(19) United States
(12) Patent Application Publication
(10) Pub. No.: US 2019/0050729 A1
(43) Pub. Date: Feb. 14, 2019

(54) DEEP LEARNING SOLUTIONS FOR SAFE, LEGAL, AND/OR EFFICIENT AUTONOMOUS DRIVING

(71) Applicant: Intel Corporation, Santa Clara, CA (US)

(72) Inventors: Barath Lakshmanan, Chandler, AZ (US); Palanivel Guruva Reddiar, Chandler, AZ (US)

(73) Assignee: Intel Corporation, Santa Clara, CA (US)

(21) Appl. No.: 15/936,323

(22) Filed: Mar. 26, 2018

(51) Int. Cl. G06N 3/08; G06N 3/04; G06N 3/063; G05D 1/00

(52) U.S. Cl. CPC G06N 3/08; G06N 3/0454; G05D 1/0088; G06N 3/0445; G06N 3/063; G06N 3/04

(57) ABSTRACT

Methods and apparatus relating to deep learning solutions for safe, legal, and/or efficient autonomous driving are described. In an embodiment, first logic determines a geographic location of a vehicle, a weather condition at the geographic location, and a maneuver for the vehicle based at least in part on sensor data and a target location. Memory stores data corresponding to the geographic location, the weather condition, and the maneuver. The first logic causes one or more motion planning logic to actuate or control movement of the vehicle based on the stored data. Other embodiments are also disclosed and claimed.

### FIELD

The present disclosure generally relates to the field of electronics. More particularly, an embodiment relates to deep learning solutions for safe, legal, and/or efficient autonomous driving.

### BACKGROUND

Autonomous driving promises a world where a vehicle can transport its passengers from point A to point B with ultimate safety and with minimal human intervention.

To achieve these goals, several sensors may be used. However, sensor data alone cannot accomplish the goal of transporting passengers from point A to point B. For example, handling different scenarios (in this stochastic world) can be difficult with traditional architectures for autonomous driving.

Accordingly, autonomous driving can significantly benefit from solutions that address different scenarios that might arise.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 illustrates a block diagram for an autonomous driving architecture, according to an embodiment.

FIGS. 2, 3, and 4 illustrate various embodiments that may be used to determine geographical location, maneuver, and weather information based on sensor data and by utilizing deep learning networks, according to some embodiments.

FIGS. 5 and 6 illustrates block diagrams of embodiments of computing systems, which may be utilized in various embodiments discussed herein.

FIGS. 7 and 8 illustrate various components of processors in accordance with some embodiments.

FIG. 9 illustrates a machine learning software stack, according to an embodiment.

FIG. 10A-10B illustrate layers of exemplary deep neural networks.

FIG. 11 illustrates an exemplary recurrent neural network.

FIG. 12 illustrates training and deployment of a deep neural network.

FIG. 13 is a block diagram illustrating distributed learning.

### DETAILED DESCRIPTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware, software, firmware, or some combination thereof.

As mentioned above, sensor data alone cannot be used to accomplish the goal of transporting passengers from point A to point B. For example, handling different scenarios (in this stochastic/unpredictable world) can be difficult with traditional architectures for autonomous driving. Accordingly, autonomous driving can significantly benefit from solutions that address different scenarios that might arise. However, a traditional architecture for autonomous driving may only provide an end-to-end based architecture in a static environment. Such an architecture is not scalable for different scenarios and can be computationally expensive. And, rules of the road cannot be followed and safety cannot be assured with such unified end-to-end solutions. Also, such unified end-to-end solutions cannot assure safety in challenging road conditions.

To this end, some embodiments relate to deep learning solutions for safe, legal, and/or efficient autonomous driving. In an embodiment, multiple deep neural networks are used for driving a car autonomously. In this regard, the architecture of an autonomous driving system is redefined, e.g., moving to a top-down approach from existing bottom-up approach. For example, a new system architecture is proposed for autonomous driving technology in modern cars. The software/logic paradigm comprises deep neural network based behavioral decision making and motion planning modules. Perception and control sub-systems are infused within the neural network whenever necessary.

Also, multiple deep neural networks may be coupled to each other to achieve the goal of driving the car from point A to point B. Unlike the end-to-end systems, this modular architecture not only enables the inclusion of safety features but also incorporates road rules into the system. As discussed herein, rules of the road or road rules generally refer to the traffic rules or laws pertaining to the country or state in which the vehicle is being driven. Such techniques are highly scalable and a deep network can be trained for a number of maneuvers at different geographic locations and/or weather conditions. Hence, the appropriate model can be selected depending on the encountered environment, e.g., without any change in the software/logic architecture. By contrast, more traditional methods are computationally very expensive. One or more of the embodiments can produce better results at lower computational cost; and hence can result in lower power consumption.

In at least one embodiment, logic and/or architecture discussed with reference to the proposed embodiments are incorporated into a System on Chip (SoC or SOC) device, such as those discussed herein with reference to the figures. The SoC may then be mounted or otherwise physically coupled to a vehicle. As discussed herein, “vehicle” generally refers to any transportation device capable of being operated autonomously (with little or no human/driver intervention), such as an automobile, a truck, a motorcycle, an airplane, a helicopter, a vessel/ship, etc. whether or not the vehicle is a passenger or commercial vehicle, and regardless of the power source type used to move the vehicle (including for example power sources such as electric motor(s), combustion engine(s) (e.g., using diesel, gasoline, propane, or other fuels), combinations thereof, etc.).

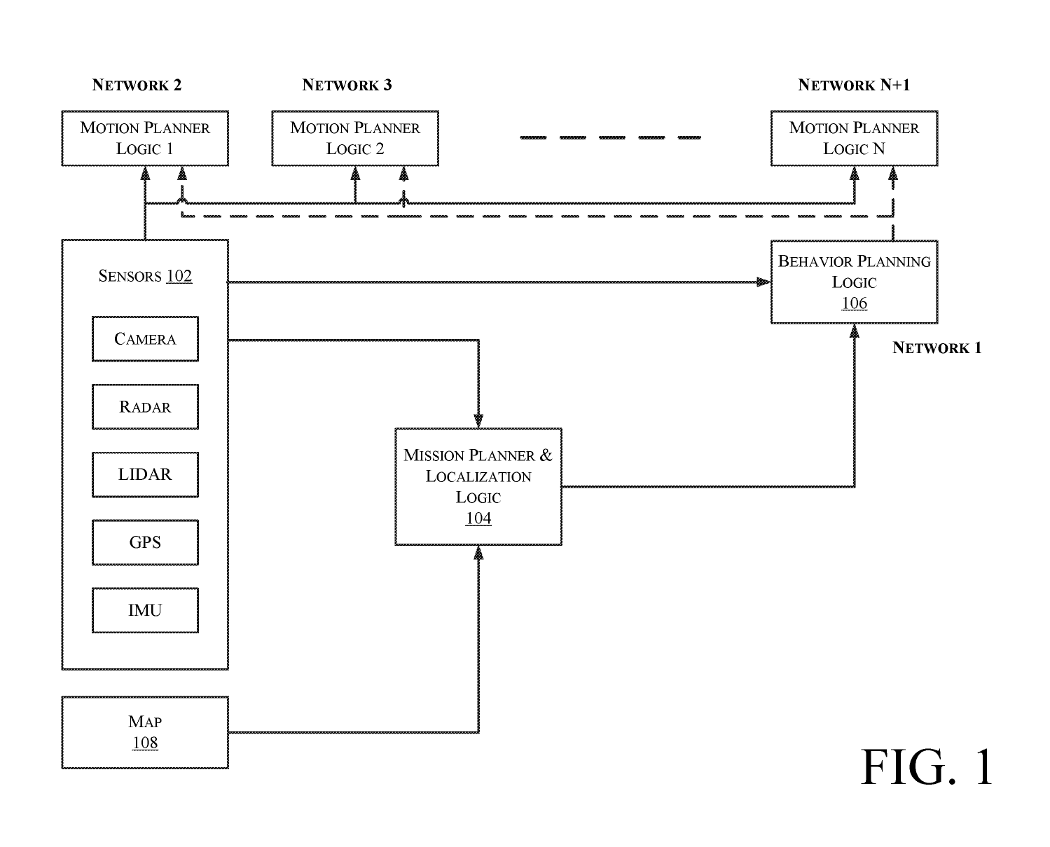

FIG. 1 illustrates a block diagram for an autonomous driving architecture, according to an embodiment. In the illustrated architecture, the modules are separated based on the system behavior and maneuvers involved in the behavior. A number of machine learning algorithms can be applied to such a system. For instance, Network 1 for the behavioral planner can be based on deep RNN, CNN. and/or reinforcement learning (RL), other networks (e.g., Networks 2 to N+1) can be based on Recurrent Neural Networks (RNNs) with previous states of the vehicle and their corresponding environment(s) as input. As discussed herein, “reinforcement learning” generally refers to learning to achieve long-term goal(s). For example, a reinforcement learning network may select the best action, e.g., by considering a future time horizon, based on the target. By contrast, traditional (without reinforcement) RNNs and CNNs may be used for immediate labels/action without having to take time into consideration. Hence, the overhead involved with different modules in more traditional architectures is eliminated as the system becomes simpler.

Referring to FIG. 1, one or more sensors 102 may include one or more of: a camera, a radar sensor, Light Detection And Ranging (or “LIDAR” which can accurately measure ranges by utilizing light in the form of a pulsed laser), GPS (Global Positioning System) sensor, or an Inertial Measurement Unit (IMU). Sensor information is provided to a mission planner and localization logic 104 as well as a behavior planning logic 106 (labeled as Network 1 in FIG. 1). The mission planner and localization logic 104 also receives map data 108. As mentioned before, a number of machine learning algorithms can be applied to the system of FIG. 1. For instance, Network 1 for the behavioral planner can be based on deep RNN, CNN, and/or reinforcement learning, while other networks (e.g., Networks 2 to N+1) can be based on Recurrent Neural Networks (RNNs) with previous states of the vehicle and their corresponding environment(s) as input.

The camera may provide a 360 degree view or awareness (e.g., with a 33 milli second frame interval). In an embodiment, four fisheye cameras may be used with overlapping visual fields to provide the 360 degree awareness.

The mission planner and localization logic 104 may perform various task such as parts of perception which can include detection (e.g., lane detection, traffic light and/or traffic light state detection, object/obstacle detection, traffic sign detection, free space detection, etc.) and/or localization (e.g., to determine a geographic location of the vehicle based on map information or sensor (e.g., camera) information). By contrast, some current autonomous driving architecture may consist of a number of sub-modules that interact with each other and the surrounding environment of the vehicle in order to actuate the car from source to destination. Such traditional systems depend on the predefined model of the environment and struggle to operate in an unstructured environment. Even with application of deep learning solutions, such systems are not guaranteed to be functionally safe and fail to strictly incorporate rules of the road.

Moreover, the mission planner and localization logic 104 may also plan the route per sensor information and map information. A high definition or normal/regular definition map may be used. Approximate localization may then be provided by logic 104 based on GPS/IMU and map information. Centimeter level localization/accurate localization may be provided by logic 104 by using high definition map together with GPS and/or IMU information. Approximate localization may be used for global mission planning, whereas accurate localization may be used for selecting immediate maneuvers. Also, approximate localization may be used initially to obtain faster routing information to facilitate a quicker start for vehicle movement, followed by accurate localization once the vehicle is moving.

In an embodiment, at any instance, only two networks may be active (i.e., network 1 and one of the other networks). By having a unified network schema for all networks, a custom hardware Intellectual Property (IP) block could be used to provide a low power consumption and/or real-time solution. With such systems, the responsibility of Network 1 could be to identify the geographic location (G), weather condition (W), maneuver (M) to be executed to reach a target location provided by the mission planner, and/or to choose the appropriate weight configuration or setting for a second network (e.g., one or more of networks 2 to N+1) in order to actuate/control the vehicle. As discussed herein, “weight configuration” generally refers to information (e.g., saved in a file) for the network which is trained on a specific scenario that has been selected. Also, “setting” refers to the mode of operation of the vehicle, e.g., all-wheel drive, rear-wheel drive, suspension height level, tire pressure level, etc.

Due to the modularity present in the architecture of FIG. 1, it is possible to insert validation mechanism/logic between different networks in order to obey rules of the road in some embodiments. Another way to incorporate safety and rules of the road is to consider the output of one network only as a desired input to a following network. Additionally, each of the individual networks could be split into multiple smaller networks in order to obtain intermediate results that are perceivable by humans/users. For instance, any network for the maneuver could be split into a network for trajectory generation and a network for control.

Networks 2 to N+1 (e.g., including motion planner logic) may then receive the sensor and/or behavior planning information to executes the movement of the vehicle (e.g., steering, braking, gear changes, etc.), and makes sure that the vehicle follows the specified trajectory. The motion planner logic 1 to N may each include one or more of: a Proportional Integral Differential (PID) controller, Linear Quadratic Regulator (LQR), and/or Model Predictive Controller (MPC).

In one embodiment, the components or deep learning network logic discussed herein may be coupled to or included with an IoT device. Moreover, an “IoT” device generally refers to a device which includes electronic processing circuitry (such as one or more processor/cores, PLA (Programmable Logic Array), Field Programmable Gate Array (FPGA), SoC, ASIC (Application Specific Integrated Circuit), etc.), memory (e.g., to store software or firmware), one or more sensors (or is otherwise coupled to one or more sensors such as a camera, motion detector, etc. such as those discussed with reference to sensor(s) 102), and network connectivity to allow the IoT device to collect and/or exchange data. IoT devices can be cheaper than traditional computing devices to allow for their proliferation at remote locations. IoT devices can also reduce costs by using existing infrastructure (such as the Internet, a (third generation (3G), fourth generation (4G), or fifth generation (5G) cellular/wireless network, etc.). More generally, an IoT device may include one or more components such as those discussed with reference to FIG. 1 et seq.

Moreover, information discussed herein (such as the sensor, detection, mission or behavior planning, weight configuration, setting(s), and/or localization information, etc.) may be stored in any type of memory (including volatile or non-volatile memory) discussed herein. Also, such information may be stored in one or more locations such as in a vehicle(s), cloud, etc.

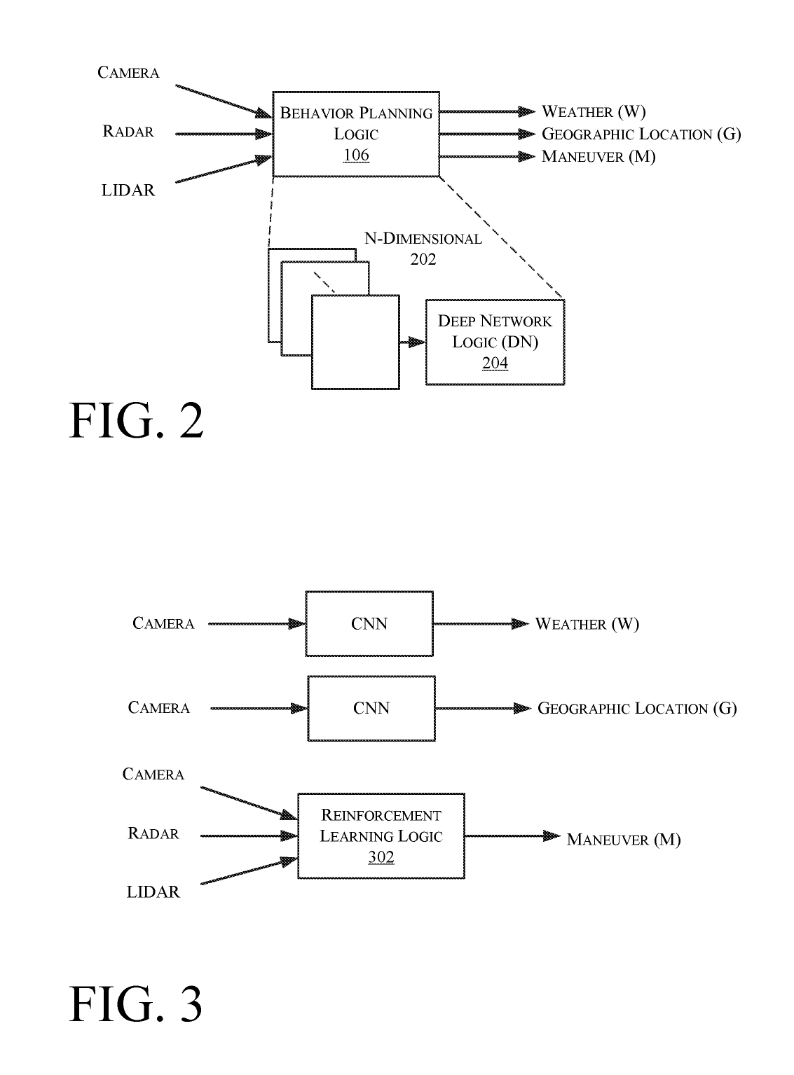

As mentioned before, the responsibility of Network 1 could be to identify the geographic location (G) (e.g., forest, city, dessert, mountain, etc.), weather condition (W), maneuver (M) to be executed to reach a target location. To this end, FIGS. 2-4 illustrate various embodiments that may be used to determine GWM information based on sensor data and by utilizing deep learning networks, according to some embodiments.

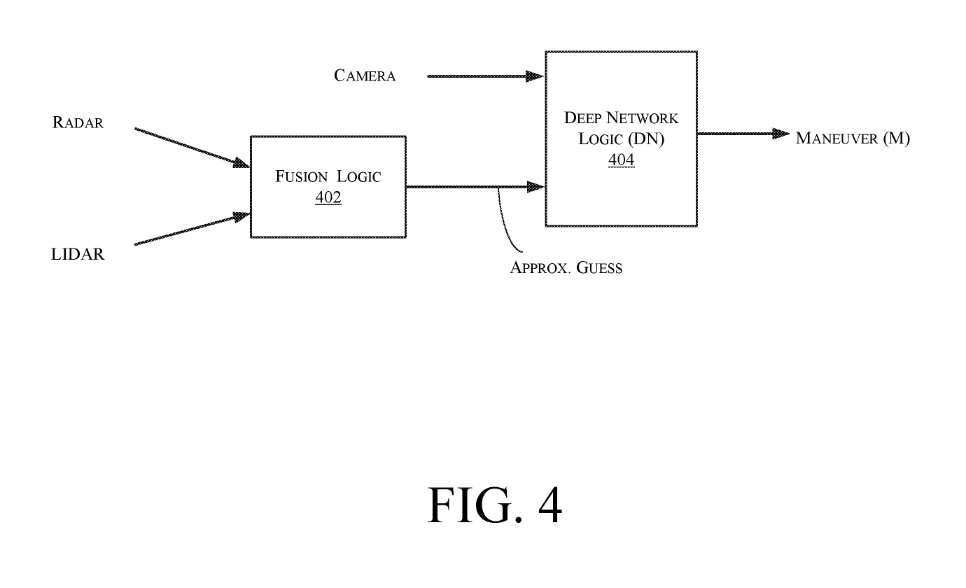

For example, FIG. 2 illustrates that camera, radar, LIDAR information may be fed to the behavior planning logic 106 to obtain GWM information. As shown, logic 106 may include a multi-dimensional raw sensor data/information that is fed to DN logic 204 to obtain the GWM information in some embodiments. The DN logic 204 may include one or more CNN and/or RNN. As shown in FIG. 3, two separate CNN may be used determine W and G information based on camera input, while a reinforcement learning logic 302 may generate the M data based on camera, radar, and LIDAR sensor input. FIG. 4 shows that radar and LIDAR may be combined by fusion logic 402 (e.g., to generate an approximate guess for object location) that is then fed to DN logic 404 with camera information to generate the corresponding maneuver information.

The GWM information can then be used to plan and/or actuate vehicle motion (e.g., through one or more networks, such as networks 2 to N+1 of FIG. 1). In an embodiment, an individual deep network may be trained with WGM as well as camera, LIDAR, and/or radar input. This individual deep network may then be used for a corresponding scenario. One or more networks (discussed with reference to FIG. 1) may also be used for each piece of GWM information to simplify deep learning logic implementations.

Furthermore, some embodiments may be applied in computing devices that include one or more processors (e.g., with one or more processor cores), such as those discussed with reference to figures herein, including for example small form factor or mobile computing devices, e.g., an IoT device, M2M device, a smartphone, tablet, UMPC (Ultra-Mobile Personal Computer), laptop computer, Ultrabook™ computing device, wearable devices (such as a smart watch, smart glasses, etc.), 2 in 1 systems, etc. Also, some embodiments are applied in computing devices that include a cooling fan as well as fanless computing devices.

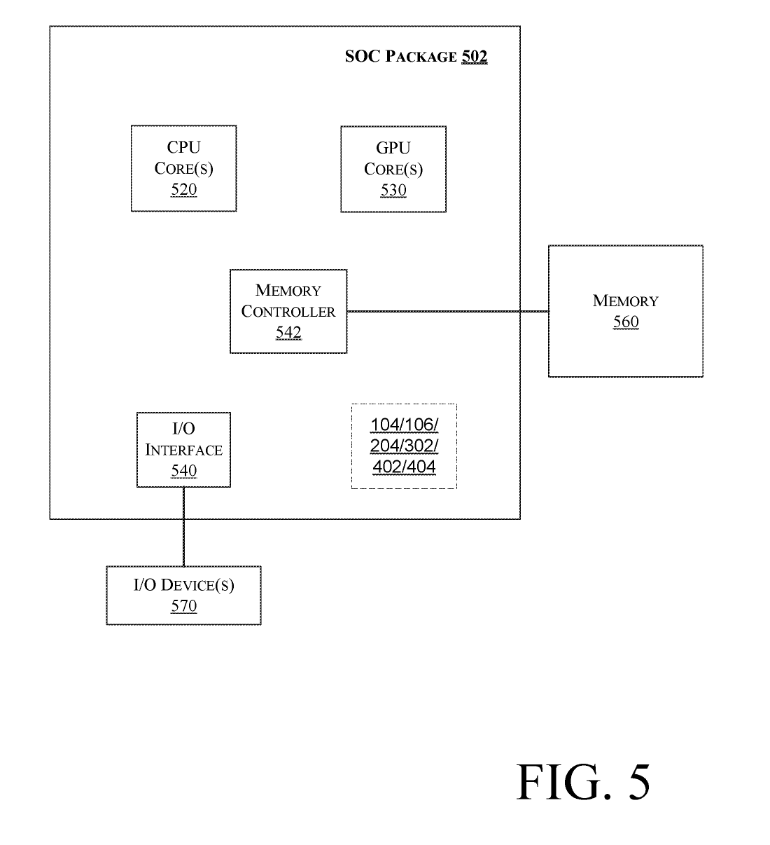

FIG. 5 illustrates a block diagram of an SOC package in accordance with an embodiment. As illustrated in FIG. 5, SOC 502 includes one or more Central Processing Unit (CPU) cores 520, one or more Graphics Processor Unit (GPU) cores 530, an Input/Output (I/O) interface 540, and a memory controller 542. Various components of the SOC package 502 may be coupled to an interconnect or bus such as discussed herein with reference to the other figures. Also, the SOC package 502 may include more or less components, such as those discussed herein with reference to the other figures. Further, each component of the SOC package 520 may include one or more other components, e.g., as discussed with reference to the other figures herein. In one embodiment, SOC package 502 (and its components) is provided on one or more Integrated Circuit (IC) die, e.g., which are packaged into a single semiconductor device.

As illustrated in FIG. 5, SOC package 502 is coupled to a memory 560 via the memory controller 542. In an embodiment, the memory 560 (or a portion of it) can be integrated on the SOC package 502.

The I/O interface 540 may be coupled to one or more I/O devices 570, e.g., via an interconnect and/or bus such as discussed herein with reference to other figures. I/O device(s) 570 may include one or more of a keyboard, a mouse, a touchpad, a display, an image/video capture device (such as a camera or camcorder/video recorder), a touch screen, a speaker, or the like.

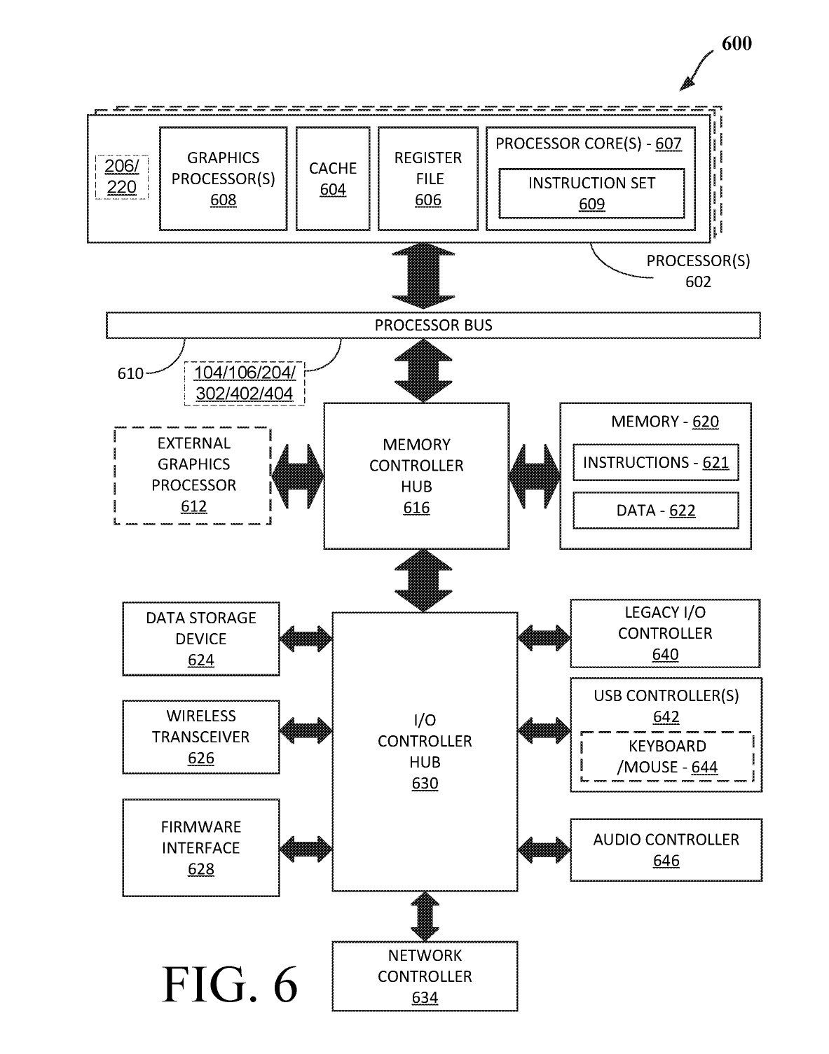

FIG. 6 is a block diagram of a processing system 600, according to an embodiment. In various embodiments the system 600 includes one or more processors 602 and one or more graphics processors 608, and may be a single processor desktop system, a multiprocessor workstation system, or a server system having a large number of processors 602 or processor cores 607. In on embodiment, the system 600 is a processing platform incorporated within a system-on-a-chip (SoC or SOC) integrated circuit for use in mobile, handheld, or embedded devices.

An embodiment of system 600 can include, or be incorporated within a server-based gaming platform, a game console, including a game and media console, a mobile gaming console, a handheld game console, or an online game console. In some embodiments system 600 is a mobile phone, smart phone, tablet computing device or mobile Internet device. Data processing system 600 can also include, couple with, or be integrated within a wearable device, such as a smart watch wearable device, smart eyewear device, augmented reality device, or virtual reality device. In some embodiments, data processing system 600 is a television or set top box device having one or more processors 602 and a graphical interface generated by one or more graphics processors 608.

In some embodiments, the one or more processors 602 each include one or more processor cores 607 to process instructions which, when executed, perform operations for system and user software. In some embodiments, each of the one or more processor cores 607 is configured to process a specific instruction set 609. In some embodiments, instruction set 609 may facilitate Complex Instruction Set Computing (CISC), Reduced Instruction Set Computing (RISC), or computing via a Very Long Instruction Word (VLIW). Multiple processor cores 607 may each process a different instruction set 609, which may include instructions to facilitate the emulation of other instruction sets. Processor core 607 may also include other processing devices, such a Digital Signal Processor (DSP).

In some embodiments, the processor 602 includes cache memory 604. Depending on the architecture, the processor 602 can have a single internal cache or multiple levels of internal cache. In some embodiments, the cache memory is shared among various components of the processor 602. In some embodiments, the processor 602 also uses an external cache (e.g., a Level-3 (L3) cache or Last Level Cache (LLC)) (not shown), which may be shared among processor cores 607 using known cache coherency techniques. A register file 606 is additionally included in processor 602 which may include different types of registers for storing different types of data (e.g., integer registers, floating point registers, status registers, and an instruction pointer register). Some registers may be general-purpose registers, while other registers may be specific to the design of the processor 602.

In some embodiments, processor 602 is coupled to a processor bus 610 to transmit communication signals such as address, data, or control signals between processor 602 and other components in system 600. In one embodiment the system 600 uses an exemplary ‘hub’ system architecture, including a memory controller hub 616 and an Input Output (I/O) controller hub 630. A memory controller hub 616 facilitates communication between a memory device and other components of system 600, while an I/O Controller Hub (ICH) 630 provides connections to I/O devices via a local I/O bus. In one embodiment, the logic of the memory controller hub 616 is integrated within the processor.

Memory device 620 can be a dynamic random access memory (DRAM) device, a static random access memory (SRAM) device, flash memory device, phase-change memory device, or some other memory device having suitable performance to serve as process memory. In one embodiment the memory device 620 can operate as system memory for the system 600, to store data 622 and instructions 621 for use when the one or more processors 602 executes an application or process. Memory controller hub 616 also couples with an optional external graphics processor 612, which may communicate with the one or more graphics processors 608 in processors 602 to perform graphics and media operations.

In some embodiments, ICH 630 enables peripherals to connect to memory device 620 and processor 602 via a high-speed I/O bus. The I/O peripherals include, but are not limited to, an audio controller 646, a firmware interface 628, a wireless transceiver 626 (e.g., Wi-Fi, Bluetooth), a data storage device 624 (e.g., hard disk drive, flash memory, etc.), and a legacy I/O controller 640 for coupling legacy (e.g., Personal System 2 (PS/2)) devices to the system. One or more Universal Serial Bus (USB) controllers 642 connect input devices, such as keyboard and mouse 644 combinations. A network controller 634 may also couple to ICH 630. In some embodiments, a high-performance network controller (not shown) couples to processor bus 610. It will be appreciated that the system 600 shown is exemplary and not limiting, as other types of data processing systems that are differently configured may also be used. For example, the I/O controller hub 630 may be integrated within the one or more processor 602, or the memory controller hub 616 and I/O controller hub 630 may be integrated into a discreet external graphics processor, such as the external graphics processor 612.

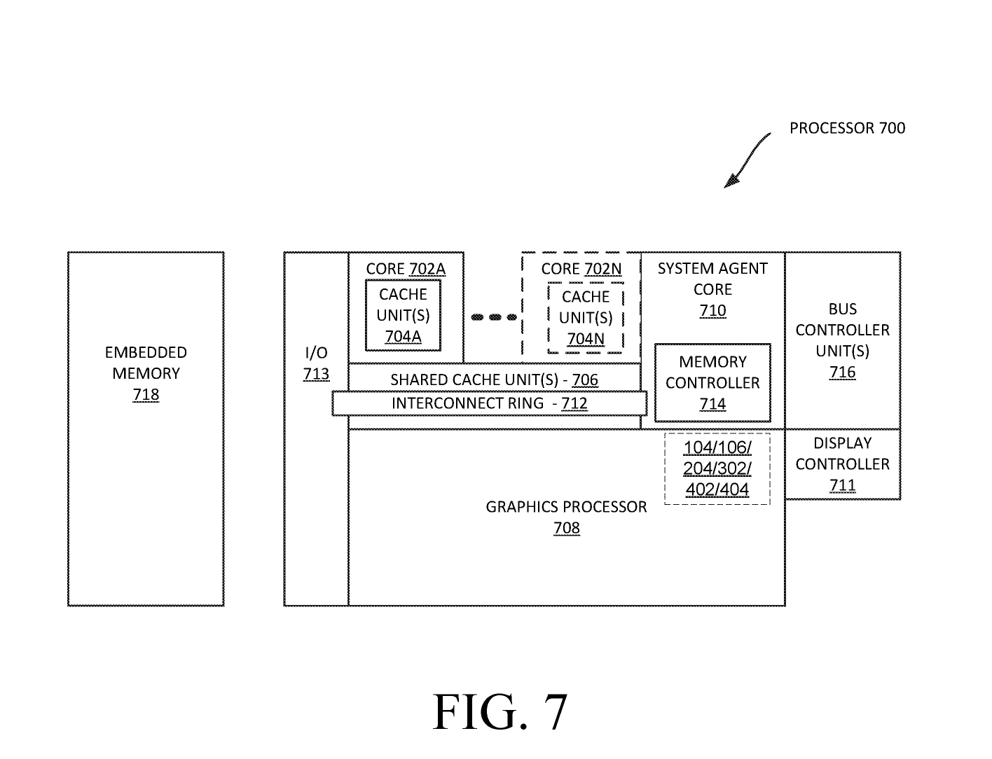

FIG. 7 is a block diagram of an embodiment of a processor 700 having one or more processor cores 702A to 702N, an integrated memory controller 714, and an integrated graphics processor 708. Those elements of FIG. 7 having the same reference numbers (or names) as the elements of any other figure herein can operate or function in any manner similar to that described elsewhere herein, but are not limited to such. Processor 700 can include additional cores up to and including additional core 702N represented by the dashed lined boxes. Each of processor cores 702A to 702N includes one or more internal cache units 704A to 704N. In some embodiments each processor core also has access to one or more shared cached units 706.

The internal cache units 704A to 704N and shared cache units 706 represent a cache memory hierarchy within the processor 700. The cache memory hierarchy may include at least one level of instruction and data cache within each processor core and one or more levels of shared mid-level cache, such as a Level 2 (L2), Level 3 (L3), Level 4 (L4), or other levels of cache, where the highest level of cache before external memory is classified as the LLC. In some embodiments, cache coherency logic maintains coherency between the various cache units 706 and 704A to 704N.

In some embodiments, processor 700 may also include a set of one or more bus controller units 716 and a system agent core 710. The one or more bus controller units 716 manage a set of peripheral buses, such as one or more Peripheral Component Interconnect buses (e.g., PCI, PCI Express). System agent core 710 provides management functionality for the various processor components. In some embodiments, system agent core 710 includes one or more integrated memory controllers 714 to manage access to various external memory devices (not shown).

In some embodiments, one or more of the processor cores 702A to 702N include support for simultaneous multi-threading. In such embodiment, the system agent core 710 includes components for coordinating and operating cores 702A to 702N during multi-threaded processing. System agent core 710 may additionally include a power control unit (PCU), which includes logic and components to regulate the power state of processor cores 702A to 702N and graphics processor 708.

In some embodiments, processor 700 additionally includes graphics processor 708 to execute graphics processing operations. In some embodiments, the graphics processor 708 couples with the set of shared cache units 706, and the system agent core 710, including the one or more integrated memory controllers 714. In some embodiments, a display controller 711 is coupled with the graphics processor 708 to drive graphics processor output to one or more coupled displays. In some embodiments, display controller 711 may be a separate module coupled with the graphics processor via at least one interconnect, or may be integrated within the graphics processor 708 or system agent core 710.

In some embodiments, a ring based interconnect unit 712 is used to couple the internal components of the processor 700. However, an alternative interconnect unit may be used, such as a point-to-point interconnect, a switched interconnect, or other techniques, including techniques well known in the art. In some embodiments, graphics processor 708 couples with the ring interconnect 712 via an I/O link 713.

The exemplary I/O link 713 represents at least one of multiple varieties of I/O interconnects, including an on package I/O interconnect which facilitates communication between various processor components and a high-performance embedded memory module 718, such as an eDRAM (or embedded DRAM) module. In some embodiments, each of the processor cores 702 to 702N and graphics processor 708 use embedded memory modules 718 as a shared Last Level Cache.

In some embodiments, processor cores 702A to 702N are homogenous cores executing the same instruction set architecture. In another embodiment, processor cores 702A to 702N are heterogeneous in terms of instruction set architecture (ISA), where one or more of processor cores 702A to 702N execute a first instruction set, while at least one of the other cores executes a subset of the first instruction set or a different instruction set. In one embodiment processor cores 702A to 702N are heterogeneous in terms of microarchitecture, where one or more cores having a relatively higher power consumption couple with one or more power cores having a lower power consumption. Additionally, processor 700 can be implemented on one or more chips or as an SoC integrated circuit having the illustrated components, in addition to other components.

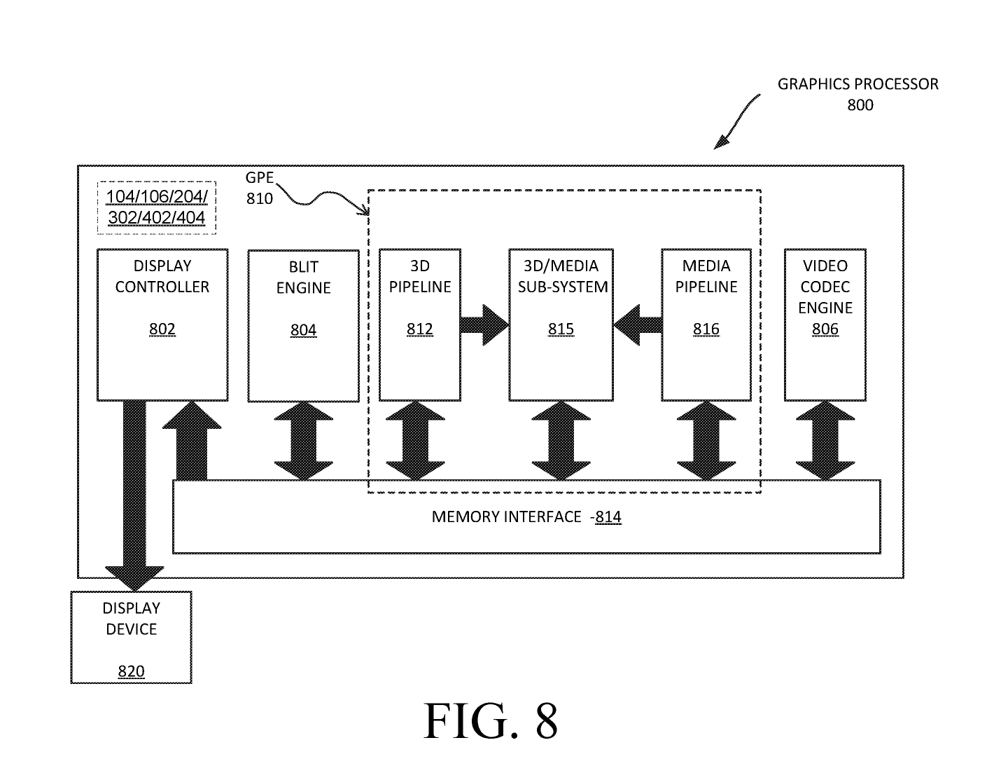

FIG. 8 is a block diagram of a graphics processor 800, which may be a discrete graphics processing unit, or may be a graphics processor integrated with a plurality of processing cores. In some embodiments, the graphics processor communicates via a memory mapped I/O interface to registers on the graphics processor and with commands placed into the processor memory. In some embodiments, graphics processor 800 includes a memory interface 814 to access memory. Memory interface 814 can be an interface to local memory, one or more internal caches, one or more shared external caches, and/or to system memory.

In some embodiments, graphics processor 800 also includes a display controller 802 to drive display output data to a display device 820. Display controller 802 includes hardware for one or more overlay planes for the display and composition of multiple layers of video or user interface elements. In some embodiments, graphics processor 800 includes a video codec engine 806 to encode, decode, or transcode media to, from, or between one or more media encoding formats, including, but not limited to Moving Picture Experts Group (MPEG) formats such as MPEG-2, Advanced Video Coding (AVC) formats such as H.264/MPEG-4 AVC, as well as the Society of Motion Picture & Television Engineers (SMPTE) 421M/VC-1, and Joint Photographic Experts Group (JPEG) formats such as JPEG, and Motion JPEG (MJPEG) formats.

In some embodiments, graphics processor 800 includes a block image transfer (BLIT) engine 804 to perform two-dimensional (2D) rasterizer operations including, for example, bit-boundary block transfers. However, in one embodiment, 8D graphics operations are performed using one or more components of graphics processing engine (GPE) 810. In some embodiments, graphics processing engine 810 is a compute engine for performing graphics operations, including three-dimensional (3D) graphics operations and media operations.

In some embodiments, GPE 810 includes a 3D pipeline 812 for performing 3D operations, such as rendering three-dimensional images and scenes using processing functions that act upon 3D primitive shapes (e.g., rectangle, triangle, etc.). The 3D pipeline 812 includes programmable and fixed function elements that perform various tasks within the element and/or spawn execution threads to a 3D/Media sub-system 815. While 3D pipeline 812 can be used to perform media operations, an embodiment of GPE 810 also includes a media pipeline 816 that is specifically used to perform media operations, such as video post-processing and image enhancement.

In some embodiments, media pipeline 816 includes fixed function or programmable logic units to perform one or more specialized media operations, such as video decode acceleration, video de-interlacing, and video encode acceleration in place of, or on behalf of video codec engine 806. In some embodiments, media pipeline 816 additionally includes a thread spawning unit to spawn threads for execution on 3D/Media sub-system 815. The spawned threads perform computations for the media operations on one or more graphics execution units included in 3D/Media sub-system 815.

In some embodiments, 3D/Media subsystem 815 includes logic for executing threads spawned by 3D pipeline 812 and media pipeline 816. In one embodiment, the pipelines send thread execution requests to 3D/Media subsystem 815, which includes thread dispatch logic for arbitrating and dispatching the various requests to available thread execution resources. The execution resources include an array of graphics execution units to process the 3D and media threads. In some embodiments, 3D/Media subsystem 815 includes one or more internal caches for thread instructions and data. In some embodiments, the subsystem also includes shared memory, including registers and addressable memory, to share data between threads and to store output data.

### Machine Learning Overview

A machine learning algorithm is an algorithm that can learn based on a set of data. Embodiments of machine learning algorithms can be designed to model high-level abstractions within a data set. For example, image recognition algorithms can be used to determine which of several categories to which a given input belong; regression algorithms can output a numerical value given an input; and pattern recognition algorithms can be used to generate translated text or perform text to speech and/or speech recognition.

An exemplary type of machine learning algorithm is a neural network. There are many types of neural networks; a simple type of neural network is a feedforward network. A feedforward network may be implemented as an acyclic graph in which the nodes are arranged in layers. Typically, a feedforward network topology includes an input layer and an output layer that are separated by at least one hidden layer. The hidden layer transforms input received by the input layer into a representation that is useful for generating output in the output layer. The network nodes are fully connected via edges to the nodes in adjacent layers, but there are no edges between nodes within each layer. Data received at the nodes of an input layer of a feedforward network are propagated (i.e., “fed forward”) to the nodes of the output layer via an activation function that calculates the states of the nodes of each successive layer in the network based on coefficients (“weights”) respectively associated with each of the edges connecting the layers. Depending on the specific model being represented by the algorithm being executed, the output from the neural network algorithm can take various forms.

Before a machine learning algorithm can be used to model a particular problem, the algorithm is trained using a training data set. Training a neural network involves selecting a network topology, using a set of training data representing a problem being modeled by the network, and adjusting the weights until the network model performs with a minimal error for all instances of the training data set. For example, during a supervised learning training process for a neural network, the output produced by the network in response to the input representing an instance in a training data set is compared to the “correct” labeled output for that instance, an error signal representing the difference between the output and the labeled output is calculated, and the weights associated with the connections are adjusted to minimize that error as the error signal is backward propagated through the layers of the network. The network is considered “trained” when the errors for each of the outputs generated from the instances of the training data set are minimized.

The accuracy of a machine learning algorithm can be affected significantly by the quality of the data set used to train the algorithm. The training process can be computationally intensive and may require a significant amount of time on a conventional general-purpose processor. Accordingly, parallel processing hardware is used to train many types of machine learning algorithms. This is particularly useful for optimizing the training of neural networks, as the computations performed in adjusting the coefficients in neural networks lend themselves naturally to parallel implementations. Specifically, many machine learning algorithms and software applications have been adapted to make use of the parallel processing hardware within general-purpose graphics processing devices.

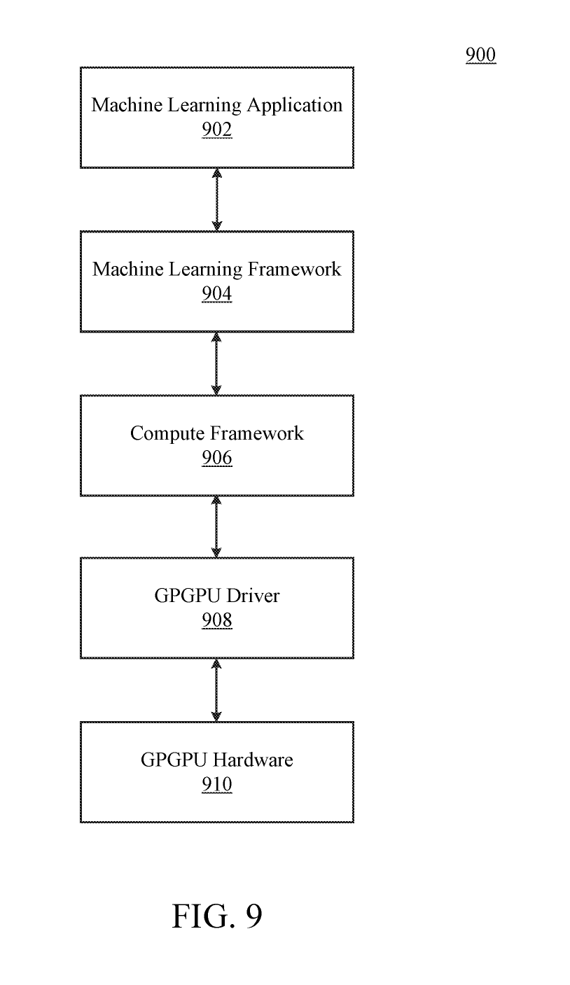

FIG. 9 is a generalized diagram of a machine learning software stack 900. A machine learning application 902 can be configured to train a neural network or other similar supervised machine learning techniques using a training dataset or to use a trained deep neural network to implement machine intelligence. Moreover, while one or more embodiments are discussed herein with reference to heavy deep learning implementations, embodiments are not limited to such implementations and any supervised machine learning algorithm can be used, such as Bayesian Network (also referred to as Bayes Net), Random Forest, Logistic Regression, SVM (Support Vector Machine), Neural Network, Deep Neural Network, or any combinations thereof. The machine learning application 902 can include training and inference functionality for a neural network and/or specialized software that can be used to train a neural network before deployment. The machine learning application 902 can implement any type of machine intelligence including but not limited to image recognition, mapping and localization, autonomous navigation, speech synthesis, medical imaging, or language translation.

Hardware acceleration for the machine learning application 902 can be enabled via a machine learning framework 904. The machine learning framework 904 can provide a library of machine learning primitives. Machine learning primitives are basic operations that are commonly performed by machine learning algorithms. Without the machine learning framework 904, developers of machine learning algorithms would be required to create and optimize the main computational logic associated with the machine learning algorithm, then re-optimize the computational logic as new parallel processors are developed. Instead, the machine learning application can be configured to perform the necessary computations using the primitives provided by the machine learning framework 904. Exemplary primitives include tensor convolutions, activation functions, and pooling, which are computational operations that are performed while training a convolutional neural network (CNN). The machine learning framework 904 can also provide primitives to implement basic linear algebra subprograms performed by many machine-learning algorithms, such as matrix and vector operations.

The machine learning framework 904 can process input data received from the machine learning application 902 and generate the appropriate input to a compute framework 906. The compute framework 906 can abstract the underlying instructions provided to the GPGPU driver 908 to enable the machine learning framework 904 to take advantage of hardware acceleration via the GPGPU hardware 910 without requiring the machine learning framework 904 to have intimate knowledge of the architecture of the GPGPU hardware 910. Additionally, the compute framework 906 can enable hardware acceleration for the machine learning framework 904 across a variety of types and generations of the GPGPU hardware 910.

The computing architecture provided by embodiments described herein can be configured to perform the types of parallel processing that is particularly suited for training and deploying neural networks for machine learning. A neural network can be generalized as a network of functions having a graph relationship. As is known in the art, there are a variety of types of neural network implementations used in machine learning. One exemplary type of neural network is the feedforward network, as previously described.

A second exemplary type of neural network is the Convolutional Neural Network (CNN). A CNN is a specialized feedforward neural network for processing data having a known, grid-like topology, such as image data. Accordingly, CNNs are commonly used for compute vision and image recognition applications, but they also may be used for other types of pattern recognition such as speech and language processing. The nodes in the CNN input layer are organized into a set of “filters” (feature detectors inspired by the receptive fields found in the retina), and the output of each set of filters is propagated to nodes in successive layers of the network. The computations for a CNN include applying the convolution mathematical operation to each filter to produce the output of that filter. Convolution is a specialized kind of mathematical operation performed by two functions to produce a third function that is a modified version of one of the two original functions. In convolutional network terminology, the first function to the convolution can be referred to as the input, while the second function can be referred to as the convolution kernel. The output may be referred to as the feature map. For example, the input to a convolution layer can be a multidimensional array of data that defines the various color components of an input image. The convolution kernel can be a multidimensional array of parameters, where the parameters are adapted by the training process for the neural network.

Recurrent neural networks (RNNs) are a family of feedforward neural networks that include feedback connections between layers. RNNs enable modeling of sequential data by sharing parameter data across different parts of the neural network. The architecture for a RNN includes cycles. The cycles represent the influence of a present value of a variable on its own value at a future time, as at least a portion of the output data from the RNN is used as feedback for processing subsequent input in a sequence. This feature makes RNNs particularly useful for language processing due to the variable nature in which language data can be composed.

The figures described below present exemplary feedforward, CNN, and RNN networks, as well as describe a general process for respectively training and deploying each of those types of networks. It will be understood that these descriptions are exemplary and non-limiting as to any specific embodiment described herein and the concepts illustrated can be applied generally to deep neural networks and machine learning techniques in general.

The exemplary neural networks described above can be used to perform deep learning. Deep learning is machine learning using deep neural networks. The deep neural networks used in deep learning are artificial neural networks composed of multiple hidden layers, as opposed to shallow neural networks that include only a single hidden layer. Deeper neural networks are generally more computationally intensive to train. However, the additional hidden layers of the network enable multistep pattern recognition that results in reduced output error relative to shallow machine learning techniques.

Deep neural networks used in deep learning typically include a front-end network to perform feature recognition coupled to a back-end network which represents a mathematical model that can perform operations (e.g., object classification, speech recognition, etc.) based on the feature representation provided to the model. Deep learning enables machine learning to be performed without requiring hand crafted feature engineering to be performed for the model. Instead, deep neural networks can learn features based on statistical structure or correlation within the input data. The learned features can be provided to a mathematical model that can map detected features to an output. The mathematical model used by the network is generally specialized for the specific task to be performed, and different models will be used to perform different task.

Once the neural network is structured, a learning model can be applied to the network to train the network to perform specific tasks. The learning model describes how to adjust the weights within the model to reduce the output error of the network. Backpropagation of errors is a common method used to train neural networks. An input vector is presented to the network for processing. The output of the network is compared to the desired output using a loss function and an error value is calculated for each of the neurons in the output layer. The error values are then propagated backwards until each neuron has an associated error value which roughly represents its contribution to the original output. The network can then learn from those errors using an algorithm, such as the stochastic gradient descent algorithm, to update the weights of the of the neural network.

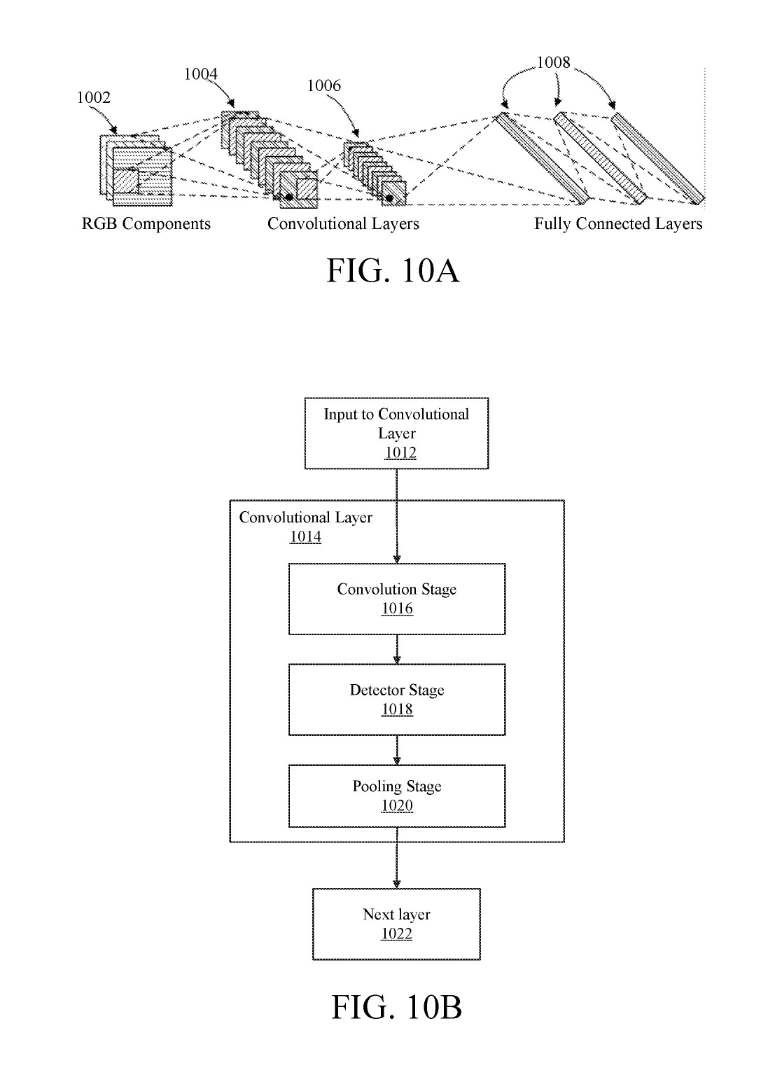

FIG. 10A-10B illustrate an exemplary convolutional neural network. FIG. 10A illustrates various layers within a CNN. As shown in FIG. 10A, an exemplary CNN used to model image processing can receive input 1002 describing the red, green, and blue (RGB) components of an input image. The input 1002 can be processed by multiple convolutional layers (e.g., first convolutional layer 1004, second convolutional layer 1006). The output from the multiple convolutional layers may optionally be processed by a set of fully connected layers 1008. Neurons in a fully connected layer have full connections to all activations in the previous layer, as previously described for a feedforward network. The output from the fully connected layers 1008 can be used to generate an output result from the network. The activations within the fully connected layers 1008 can be computed using matrix multiplication instead of convolution. Not all CNN implementations are make use of fully connected layers 1008. For example, in some implementations the second convolutional layer 1006 can generate output for the CNN.

The convolutional layers are sparsely connected, which differs from traditional neural network configuration found in the fully connected layers 1008. Traditional neural network layers are fully connected, such that every output unit interacts with every input unit. However, the convolutional layers are sparsely connected because the output of the convolution of a field is input (instead of the respective state value of each of the nodes in the field) to the nodes of the subsequent layer, as illustrated. The kernels associated with the convolutional layers perform convolution operations, the output of which is sent to the next layer. The dimensionality reduction performed within the convolutional layers is one aspect that enables the CNN to scale to process large images.

FIG. 10B illustrates exemplary computation stages within a convolutional layer of a CNN. Input to a convolutional layer 1012 of a CNN can be processed in three stages of a convolutional layer 1014. The three stages can include a convolution stage 1016, a detector stage 1018, and a pooling stage 1020. The convolution layer 1014 can then output data to a successive convolutional layer. The final convolutional layer of the network can generate output feature map data or provide input to a fully connected layer, for example, to generate a classification value for the input to the CNN.

In the convolution stage 1016 performs several convolutions in parallel to produce a set of linear activations. The convolution stage 1016 can include an affine transformation, which is any transformation that can be specified as a linear transformation plus a translation. Affine transformations include rotations, translations, scaling, and combinations of these transformations. The convolution stage computes the output of functions (e.g., neurons) that are connected to specific regions in the input, which can be determined as the local region associated with the neuron. The neurons compute a dot product between the weights of the neurons and the region in the local input to which the neurons are connected. The output from the convolution stage 1016 defines a set of linear activations that are processed by successive stages of the convolutional layer 1014.

The linear activations can be processed by a detector stage 1018. In the detector stage 1018, each linear activation is processed by a non-linear activation function. The non-linear activation function increases the nonlinear properties of the overall network without affecting the receptive fields of the convolution layer. Several types of non-linear activation functions may be used. One particular type is the rectified linear unit (ReLU), which uses an activation function defined as f(x)=max (0,x), such that the activation is thresholded at zero.

The pooling stage 1020 uses a pooling function that replaces the output of the second convolutional layer 1006 with a summary statistic of the nearby outputs. The pooling function can be used to introduce translation invariance into the neural network, such that small translations to the input do not change the pooled outputs. Invariance to local translation can be useful in scenarios where the presence of a feature in the input data is more important than the precise location of the feature. Various types of pooling functions can be used during the pooling stage 1020, including max pooling, average pooling, and 12-norm pooling. Additionally, some CNN implementations do not include a pooling stage. Instead, such implementations substitute and additional convolution stage having an increased stride relative to previous convolution stages.

The output from the convolutional layer 1014 can then be processed by the next layer 1022. The next layer 1022 can be an additional convolutional layer or one of the fully connected layers 1008. For example, the first convolutional layer 1004 of FIG. 10A can output to the second convolutional layer 1006, while the second convolutional layer can output to a first layer of the fully connected layers 1008.

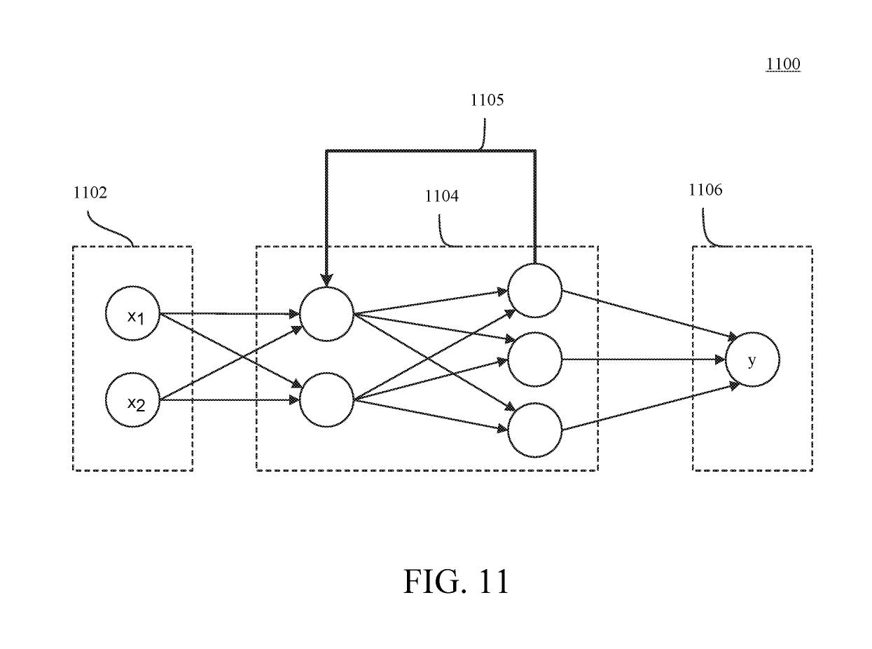

FIG. 11 illustrates an exemplary recurrent neural network. In a recurrent neural network (RNN), the previous state of the network influences the output of the current state of the network. RNNs can be built in a variety of ways using a variety of functions. The use of RNNs generally revolves around using mathematical models to predict the future based on a prior sequence of inputs. For example, an RNN may be used to perform statistical language modeling to predict an upcoming word given a previous sequence of words. The illustrated RNN 1100 can be described as having an input layer 1102 that receives an input vector, hidden layers 1104 to implement a recurrent function, a feedback mechanism 1105 to enable a ‘memory’ of previous states, and an output layer 1106 to output a result. The RNN 1100 operates based on time-steps. The state of the RNN at a given time step is influenced based on the previous time step via the feedback mechanism 1105. For a given time step, the state of the hidden layers 1104 is defined by the previous state and the input at the current time step. An initial input (x1) at a first time step can be processed by the hidden layer 1104. A second input (x2) can be processed by the hidden layer 1104 using state information that is determined during the processing of the initial input (x1). A given state can be computed as s_t=f(Ux_t+Ws_(t−1)), where U and W are parameter matrices. The function f is generally a nonlinearity, such as the hyperbolic tangent function (Tan h) or a variant of the rectifier function f(x)=max (0,x). However, the specific mathematical function used in the hidden layers 1104 can vary depending on the specific implementation details of the RNN 1100.

In addition to the basic CNN and RNN networks described, variations on those networks may be enabled. One example RNN variant is the long short-term memory (LSTM) RNN. LSTM RNNs are capable of learning long-term dependencies that may be necessary for processing longer sequences of language. A variant on the CNN is a convolutional deep belief network, which has a structure similar to a CNN and is trained in a manner similar to a deep belief network. A deep belief network (DBN) is a generative neural network that is composed of multiple layers of stochastic (random) variables. DBNs can be trained layer-by-layer using greedy unsupervised learning. The learned weights of the DBN can then be used to provide pre-train neural networks by determining an optimal initial set of weights for the neural network.

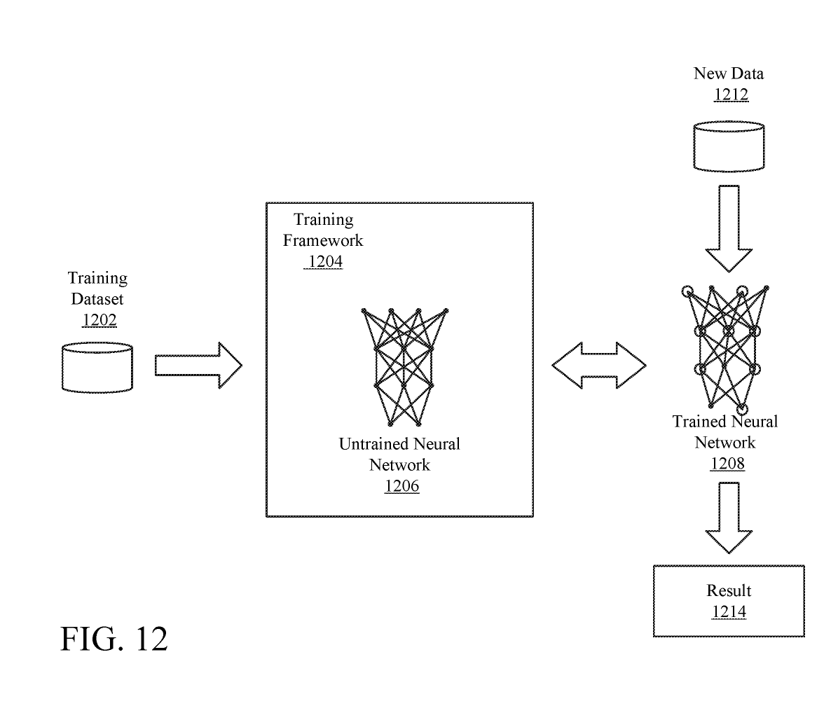

FIG. 12 illustrates training and deployment of a deep neural network. Once a given network has been structured for a task the neural network is trained using a training dataset 1202. Various training frameworks have been developed to enable hardware acceleration of the training process. For example, the machine learning framework 904 of FIG. 9 may be configured as a training framework 1204. The training framework 1204 can hook into an untrained neural network 1206 and enable the untrained neural net to be trained using the parallel processing resources described herein to generate a trained neural network 1208. To start the training process the initial weights may be chosen randomly or by pre-training using a deep belief network. The training cycle then be performed in either a supervised or unsupervised manner.

Supervised learning is a learning method in which training is performed as a mediated operation, such as when the training dataset 1202 includes input paired with the desired output for the input, or where the training dataset includes input having known output and the output of the neural network is manually graded. The network processes the inputs and compares the resulting outputs against a set of expected or desired outputs. Errors are then propagated back through the system. The training framework 1204 can adjust to adjust the weights that control the untrained neural network 1206. The training framework 1204 can provide tools to monitor how well the untrained neural network 1206 is converging towards a model suitable to generating correct answers based on known input data. The training process occurs repeatedly as the weights of the network are adjusted to refine the output generated by the neural network. The training process can continue until the neural network reaches a statistically desired accuracy associated with a trained neural network 1208. The trained neural network 1208 can then be deployed to implement any number of machine learning operations.

Unsupervised learning is a learning method in which the network attempts to train itself using unlabeled data. Thus, for unsupervised learning the training dataset 1202 will include input data without any associated output data. The untrained neural network 1206 can learn groupings within the unlabeled input and can determine how individual inputs are related to the overall dataset. Unsupervised training can be used to generate a self-organizing map, which is a type of trained neural network 1207 capable of performing operations useful in reducing the dimensionality of data. Unsupervised training can also be used to perform anomaly detection, which allows the identification of data points in an input dataset that deviate from the normal patterns of the data.

Variations on supervised and unsupervised training may also be employed. Semi-supervised learning is a technique in which in the training dataset 1202 includes a mix of labeled and unlabeled data of the same distribution. Incremental learning is a variant of supervised learning in which input data is continuously used to further train the model. Incremental learning enables the trained neural network 1208 to adapt to the new data 1212 without forgetting the knowledge instilled within the network during initial training.

Whether supervised or unsupervised, the training process for particularly deep neural networks may be too computationally intensive for a single compute node. Instead of using a single compute node, a distributed network of computational nodes can be used to accelerate the training process.

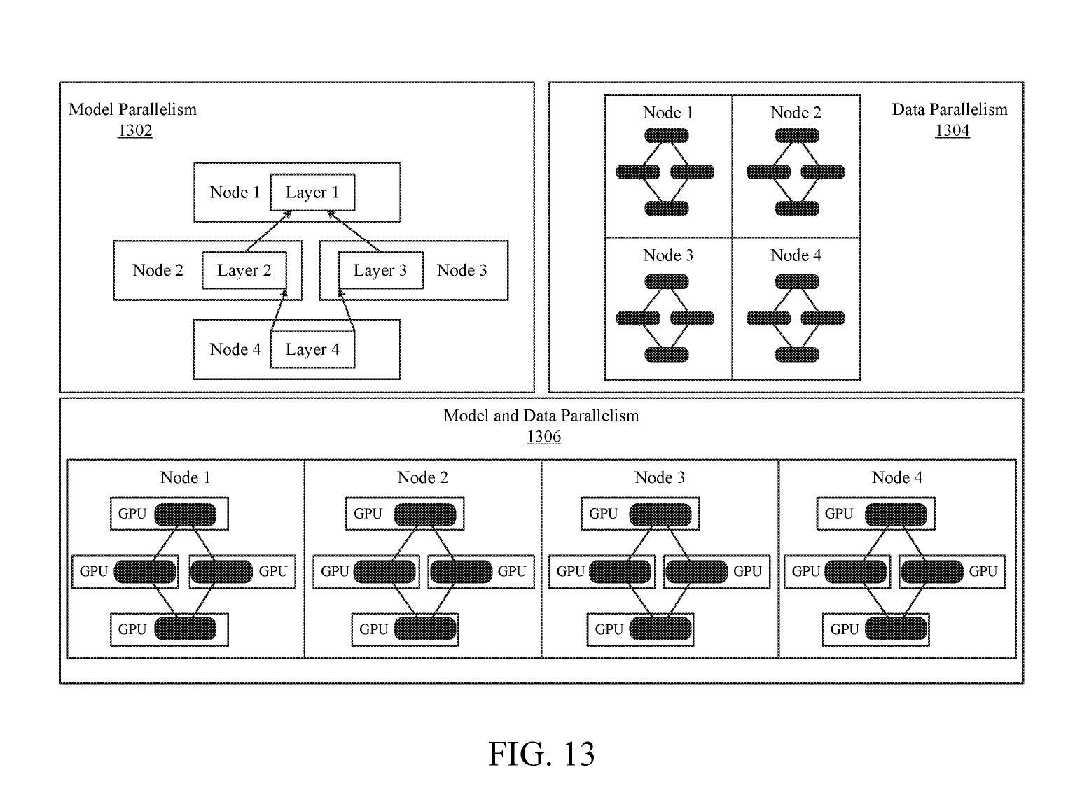

FIG. 13 is a block diagram illustrating distributed learning. Distributed learning is a training model that uses multiple distributed computing nodes to perform supervised or unsupervised training of a neural network. The distributed computational nodes can each include one or more host processors and one or more of the general-purpose processing nodes. As illustrated, distributed learning can be performed model parallelism 1302, data parallelism 1304, or a combination of model and data parallelism 1304.

In model parallelism 1302, different computational nodes in a distributed system can perform training computations for different parts of a single network. For example, each layer of a neural network can be trained by a different processing node of the distributed system. The benefits of model parallelism include the ability to scale to particularly large models. Splitting the computations associated with different layers of the neural network enables the training of very large neural networks in which the weights of all layers would not fit into the memory of a single computational node. In some instances, model parallelism can be particularly useful in performing unsupervised training of large neural networks.

In data parallelism 1304, the different nodes of the distributed network have a complete instance of the model and each node receives a different portion of the data. The results from the different nodes are then combined. While different approaches to data parallelism are possible, data parallel training approaches all require a technique of combining results and synchronizing the model parameters between each node. Exemplary approaches to combining data include parameter averaging and update based data parallelism. Parameter averaging trains each node on a subset of the training data and sets the global parameters (e.g., weights, biases) to the average of the parameters from each node. Parameter averaging uses a central parameter server that maintains the parameter data. Update based data parallelism is similar to parameter averaging except that instead of transferring parameters from the nodes to the parameter server, the updates to the model are transferred. Additionally, update based data parallelism can be performed in a decentralized manner, where the updates are compressed and transferred between nodes.

Combined model and data parallelism 1306 can be implemented, for example, in a distributed system in which each computational node includes multiple GPUs. Each node can have a complete instance of the model with separate GPUs within each node are used to train different portions of the model.

Distributed training has increased overhead relative to training on a single machine. However, the parallel processors and GPGPUs described herein can each implement various techniques to reduce the overhead of distributed training, including techniques to enable high bandwidth GPU-to-GPU data transfer and accelerated remote data synchronization.

Machine learning can be applied to solve a variety of technological problems, including but not limited to computer vision, autonomous driving and navigation, speech recognition, and language processing. Computer vision has traditionally been one of the most active research areas for machine learning applications. Applications of computer vision range from reproducing human visual abilities, such as recognizing faces, to creating new categories of visual abilities. For example, computer vision applications can be configured to recognize sound waves from the vibrations induced in objects visible in a video. Parallel processor accelerated machine learning enables computer vision applications to be trained using significantly larger training dataset than previously feasible and enables inferencing systems to be deployed using low power parallel processors.

Parallel processor accelerated machine learning has autonomous driving applications including lane and road sign recognition, obstacle avoidance, navigation, and driving control. Accelerated machine learning techniques can be used to train driving models based on datasets that define the appropriate responses to specific training input. The parallel processors described herein can enable rapid training of the increasingly complex neural networks used for autonomous driving solutions and enables the deployment of low power inferencing processors in a mobile platform suitable for integration into autonomous vehicles.

Parallel processor accelerated deep neural networks have enabled machine learning approaches to automatic speech recognition (ASR). ASR includes the creation of a function that computes the most probable linguistic sequence given an input acoustic sequence. Accelerated machine learning using deep neural networks have enabled the replacement of the hidden Markov models (HMMs) and Gaussian mixture models (GMMs) previously used for ASR.

Parallel processor accelerated machine learning can also be used to accelerate natural language processing. Automatic learning procedures can make use of statistical inference algorithms to produce models that are robust to erroneous or unfamiliar input. Exemplary natural language processor applications include automatic machine translation between human languages.

The parallel processing platforms used for machine learning can be divided into training platforms and deployment platforms. Training platforms are generally highly parallel and include optimizations to accelerate multi-GPU single node training and multi-node, multi-GPU training, while deployed machine learning (e.g., inferencing) platforms generally include lower power parallel processors suitable for use in products such as cameras, autonomous robots, and autonomous vehicles.

The following examples pertain to further embodiments. Example 1 includes an apparatus comprising: behavior planning logic to determine a geographic location of a vehicle, a weather condition at the geographic location, and a maneuver for the vehicle based at least in part on sensor data and a target location; and memory to store data corresponding to the geographic location, the weather condition, and the maneuver, wherein the behavior planning logic is to cause one or more motion planning logic to actuate or control movement of the vehicle based on the stored data. Example 2 includes the apparatus of example 1, wherein the behavior planning logic comprises one or more Convolutional Neural Networks (CNNs), wherein the one or more motion planning logic comprise Recurrent Neural Networks (RNNs). Example 3 includes the apparatus of example 1, wherein the maneuver is to be executed to cause the vehicle to reach the target location. Example 4 includes the apparatus of example 1, comprising mission planner and localization logic to provide the target location based on map data. Example 5 includes the apparatus of example 1, comprising mission planner and localization logic to perform one or more tasks corresponding to a detection operation and a localization operation. Example 6 includes the apparatus of example 5, wherein the detection operation is one of: lane detection, traffic light detection, traffic light state detection, object or obstacle detection, traffic sign detection, or free space detection. Example 7 includes the apparatus of example 5, wherein the localization operation includes determination of the geographic location of the vehicle based on map data. Example 8 includes the apparatus of example 1, wherein the behavior planning logic is to select a weight configuration or setting for the one or more motion planning logic to actuate or control movement of the vehicle. Example 9 includes the apparatus of example 8, comprising validation logic coupled between the one or more motion planning logic to comply with one or more road rules. Example 10 includes the apparatus of example 1, wherein sensor data is to be detected at one or more of: a camera, a Light Detection And Ranging (LIDAR) sensor, a radar, a Global Positioning System (GPS) sensor, an Inertial Measurement Unit. Example 11 includes the apparatus of example 1, wherein the behavior planning logic comprises: a first neural network to determine the geographic location based on camera information; a second neural network to determine the weather condition based on the camera information; and a third neural network to determine the maneuver based on the camera information, radar information, and LIDAR information. Example 12 includes the apparatus of example 11, wherein the first and second neural networks are to comprise Convolutional Neural Networks (CNNs). Example 13 includes the apparatus of example 1, wherein the behavior planning logic comprises a fusion logic to combine radar and LIDAR information to generate an approximate object location, wherein a deep network logic is to determine the maneuver based on camera data and the approximate object location. Example 14 includes the apparatus of example 1, wherein the behavior planning logic is to operate based on a deep reinforcement learning neural network. Example 15 includes the apparatus of example 1, wherein an Internet of Things (IoT) device or the vehicle comprises the behavior planning logic or the memory. Example 16 includes the apparatus of example 1, wherein a processor, having one or more processor cores, comprises the behavior planning logic. Example 17 includes the apparatus of example 1, wherein a single integrated device comprises one or more of: a processor, the behavior planning logic, and the memory. Example 18 includes a computer-readable medium comprising one or more instructions that when executed on at least one processor configure the at least one processor to perform one or more operations to: cause behavior planning logic to determine a geographic location of a vehicle, a weather condition at the geographic location, and a maneuver for the vehicle based at least in part on sensor data and a target location; and store data corresponding to the geographic location, the weather condition, and the maneuver, wherein the behavior planning logic is to cause one or more motion planning logic to actuate or control movement of the vehicle based on the stored data. Example 19 includes the computer-readable medium of example 18, further comprising one or more instructions that when executed on the at least one processor configure the at least one processor to perform one or more operations to cause mission planner and localization logic to provide the target location based on map data. Example 20 includes the computer-readable medium of example 18, further comprising one or more instructions that when executed on the at least one processor configure the at least one processor to perform one or more operations to cause mission planner and localization logic to perform one or more tasks corresponding to a detection operation and a localization operation. Example 21 includes the computer-readable medium of example 18, further comprising one or more instructions that when executed on the at least one processor configure the at least one processor to perform one or more operations to cause the behavior planning logic to select a weight configuration or setting for the one or more motion planning logic to actuate or control movement of the vehicle. Example 22 includes the computer-readable medium of example 18, wherein the behavior planning logic comprises: a first neural network to determine the geographic location based on camera information; a second neural network to determine the weather condition based on the camera information; and a third neural network to determine the maneuver based on the camera information, radar information, and LIDAR information.

Example 23 includes a computing system comprising: a processor having one or more processor cores; behavior planning logic to determine a geographic location of a vehicle, a weather condition at the geographic location, and a maneuver for the vehicle based at least in part on sensor data and a target location; and memory, coupled to the processor, to store one or more bits of data corresponding to the geographic location, the weather condition, and the maneuver, wherein the behavior planning logic is to cause one or more motion planning logic to actuate or control movement of the vehicle based on the stored data. Example 24 includes the system of example 23, wherein the processor comprises a Graphics Processing Unit (GPU). Example 25 includes the system of example 23, wherein the processor comprises the behavior planning logic.

Example 26 includes an apparatus comprising means to perform a method as set forth in any preceding example. Example 27 includes machine-readable storage including machine-readable instructions, when executed, to implement a method or realize an apparatus as set forth in any preceding example.

In various embodiments, the operations discussed herein, e.g., with reference to FIG. 1 et seq., may be implemented as hardware (e.g., logic circuitry), software, firmware, or combinations thereof, which may be provided as a computer program product, e.g., including a tangible (e.g., non-transitory) machine-readable or computer-readable medium having stored thereon instructions (or software procedures) used to program a computer to perform a process discussed herein. The machine-readable medium may include a storage device such as those discussed with respect to FIG. 1 et seq.

Additionally, such computer-readable media may be downloaded as a computer program product, wherein the program may be transferred from a remote computer (e.g., a server) to a requesting computer (e.g., a client) by way of data signals provided in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1. An apparatus comprising:
behavior planning logic to determine a geographic location of a vehicle, a weather condition at the geographic location, and a maneuver for the vehicle based at least in part on sensor data and a target location; and
memory to store data corresponding to the geographic location, the weather condition, and the maneuver,
wherein the behavior planning logic is to cause one or more motion planning logic to actuate or control movement of the vehicle based on the stored data.

2. The apparatus of claim 1, wherein the behavior planning logic comprises one or more Convolutional Neural Networks (CNNs), wherein the one or more motion planning logic comprise Recurrent Neural Networks (RNNs).

3. The apparatus of claim 1, wherein the maneuver is to be executed to cause the vehicle to reach the target location.

4. The apparatus of claim 1, comprising mission planner and localization logic to provide the target location based on map data.

5. The apparatus of claim 1, comprising mission planner and localization logic to perform one or more tasks corresponding to a detection operation and a localization operation.

6. The apparatus of claim 5, wherein the detection operation is one of: lane detection, traffic light detection, traffic light state detection, object or obstacle detection, traffic sign detection, or free space detection.

7. The apparatus of claim 5, wherein the localization operation includes determination of the geographic location of the vehicle based on map data.

8. The apparatus of claim 1, wherein the behavior planning logic is to select a weight configuration or setting for the one or more motion planning logic to actuate or control movement of the vehicle.

9. The apparatus of claim 8, comprising validation logic coupled between the one or more motion planning logic to comply with one or more road rules.

10. The apparatus of claim 1, wherein sensor data is to be detected at one or more of: a camera, a Light Detection And Ranging (LIDAR) sensor, a radar, a Global Positioning System (GPS) sensor, an Inertial Measurement Unit.

11. The apparatus of claim 1, wherein the behavior planning logic comprises: a first neural network to determine the geographic location based on camera information; a second neural network to determine the weather condition based on the camera information; and a third neural network to determine the maneuver based on the camera information, radar information, and LIDAR information.

12. The apparatus of claim 11, wherein the first and second neural networks are to comprise Convolutional Neural Networks (CNNs).

13. The apparatus of claim 1, wherein the behavior planning logic comprises a fusion logic to combine radar and LIDAR information to generate an approximate object location, wherein a deep network logic is to determine the maneuver based on camera data and the approximate object location.

14. The apparatus of claim 1, wherein the behavior planning logic is to operate based on a deep reinforcement learning neural network.

15. The apparatus of claim 1, wherein an Internet of Things (IoT) device or the vehicle comprises the behavior planning logic or the memory.

16. The apparatus of claim 1, wherein a processor, having one or more processor cores, comprises the behavior planning logic.

17. The apparatus of claim 1, wherein a single integrated device comprises one or more of: a processor, the behavior planning logic, and the memory.

18. A computer-readable medium comprising one or more instructions that when executed on at least one processor configure the at least one processor to perform one or more operations to:
cause behavior planning logic to determine a geographic location of a vehicle, a weather condition at the geographic location, and a maneuver for the vehicle based at least in part on sensor data and a target location; and
store data corresponding to the geographic location, the weather condition, and the maneuver,
wherein the behavior planning logic is to cause one or more motion planning logic to actuate or control movement of the vehicle based on the stored data.

19. The computer-readable medium of claim 18, further comprising one or more instructions that when executed on the at least one processor configure the at least one processor to perform one or more operations to cause mission planner and localization logic to provide the target location based on map data.

20. The computer-readable medium of claim 18, further comprising one or more instructions that when executed on the at least one processor configure the at least one processor to perform one or more operations to cause mission planner and localization logic to perform one or more tasks corresponding to a detection operation and a localization operation.

21. The computer-readable medium of claim 18, further comprising one or more instructions that when executed on the at least one processor configure the at least one processor to perform one or more operations to cause the behavior planning logic to select a weight configuration or setting for the one or more motion planning logic to actuate or control movement of the vehicle.

22. The computer-readable medium of claim 18, wherein the behavior planning logic comprises: a first neural network to determine the geographic location based on camera information; a second neural network to determine the weather condition based on the camera information; and a third neural network to determine the maneuver based on the camera information, radar information, and LIDAR information.

23. A computing system comprising:
a processor having one or more processor cores;
behavior planning logic to determine a geographic location of a vehicle, a weather condition at the geographic location, and a maneuver for the vehicle based at least in part on sensor data and a target location; and
memory, coupled to the processor, to store one or more bits of data corresponding to the geographic location, the weather condition, and the maneuver,
wherein the behavior planning logic is to cause one or more motion planning logic to actuate or control movement of the vehicle based on the stored data.

24. The system of claim 23, wherein the processor comprises a Graphics Processing Unit (GPU).

25. The system of claim 23, wherein the processor comprises the behavior planning logic.
